(19) United States
(12) Patent Application Publication
(10) Pub. No.: US 2024/0359733 A1
(43) Pub. Date: Oct. 31, 2024

(54) METHODS, SYSTEMS, AND VEHICLES HAVING TRAILER STEERING ASSISTANCE INCLUDING FRONT WHEEL STEERING

(71) Applicant: GM GLOBAL TECHNOLOGY OPERATIONS LLC, Detroit, MI (US)

(72) Inventors: Avesta Goodarzi, Whitby (CA); Hojjat Izadi, North York (CA)

(73) Assignee: GM GLOBAL TECHNOLOGY OPERATIONS LLC, Detroit, MI (US)

(21) Appl. No.: 18/306,353

(22) Filed: Apr. 25, 2023

(51) Int. Cl. B62D 6/00; B62D 15/02

(52) U.S. Cl. CPC B62D 6/002; B62D 15/025

(57) ABSTRACT

Methods and systems are provided for operating a vehicle having a trailer pivotally coupled thereto for towing of the trailer. The system may include a steering system including a steering wheel for controlling front wheels of the vehicle, a sensor system configured to sense a steering wheel angle of the steering wheel, and a computer system onboard the vehicle and operatively coupled to the steering system and the sensor system, the computer system configured to, by a processor: monitor the steering wheel angle of the steering wheel of the vehicle while the vehicle is operated to move the vehicle and the trailer in a reverse direction relative thereto, and adjust front wheels of the vehicle in a direction relative to a central longitudinal axis of the vehicle such that the trailer turns in an opposite direction as a direction of rotation of the steering wheel about the axis thereof.

### INTRODUCTION

The technical field generally relates to vehicle trailers, and more particularly relates to methods and systems for automated and dynamic steering assistance when towing a trailer with a vehicle, particularly when maneuvering the trailer in a reverse direction.

Vehicles configured to tow a trailer capable of hauling a load are typically equipped with a connection apparatus that may include, for example, a hitch. When towing a trailer with a vehicle that includes this type of connection to the trailer, maneuvering the trailer in a reverse direction may be particularly difficult, especially for an inexperienced operator. In particular, maneuvering the trailer in reverse may require counter steering by the operator that may not be intuitive relative to the normal operation of the vehicle.

Accordingly, it is desirable to provide methods or systems that are capable of promoting ease of maneuvering a trailer, especially in a reverse direction. Furthermore, other desirable features and characteristics of the present invention will become apparent from the subsequent detailed description and the appended claims, taken in conjunction with the accompanying drawings and the foregoing technical field and background.

### SUMMARY

A method is provided for operating a vehicle having a trailer pivotally coupled thereto for towing of the trailer. In one embodiment, the method includes monitoring, by a processor onboard the vehicle, a steering wheel angle of a steering wheel of the vehicle while the vehicle is operated to move the vehicle and the trailer in a reverse direction relative thereto, the steering wheel angle defined between a position of the steering wheel rotated about an axis thereof relative to a null position thereof, and adjusting, by the processor, front wheels of the vehicle in a direction relative to a central longitudinal axis of the vehicle such that the trailer turns in an opposite direction as a direction of rotation of the steering wheel about the axis thereof.

In various embodiments, the method may include monitoring, by the processor, a speed of the vehicle and a hitch articulation angle of the vehicle while the vehicle is operated to move the vehicle and the trailer in the reverse direction relative thereto, the hitch articulation angle defined between the central longitudinal axis of the vehicle and a central longitudinal axis of the trailer, determining, by the processor, a desired hitch articulation angle based on the steering wheel angle, determining, by the processor, a calculated front steering angle based on the desired hitch articulation angle, the speed of the vehicle, and the hitch articulation angle, a front steering angle defined between a first geometric line coplanar with and perpendicular to an axis of rotation of front wheels of the vehicle and the central longitudinal axis of the vehicle, wherein the calculated front steering angle is configured to cause relative movement between the vehicle and the trailer such that the hitch articulation angle transitions to the desired hitch articulation angle, and adjusting, by the processor, the front wheels of the vehicle in a direction relative to the central longitudinal axis of the vehicle such that the front steering angle matches the calculated front steering angle.

In various embodiments, the step of determining the desired hitch articulation angle may be performed in accordance with:

$${θ}_{d} = \{ \begin{matrix}{δ}_{w} \leq - {δ}^{*} & {θ}_{m ax} \\ - {δ}^{*} < {δ}_{w} < {δ}^{*} & - K {δ}_{w} \\ {δ}_{w} \geq {δ}^{*} & - {θ}_{ma x}\end{matrix} .$$

In various embodiments, the method may include receiving, by the processor, vehicle data that includes dimensions of the vehicle and trailer data that includes dimensions of the trailer coupled to the vehicle. The step of determining the calculated front steering angle may be performed based on the desired hitch articulation angle, the speed of the vehicle, the hitch articulation angle, the vehicle data, and the trailer data.

In various embodiments, the step of determining the calculated front steering angle may be performed in accordance with:

$$tan {δ}_{f} = \frac{τ \frac{L}{V} ( {θ}_{d} - θ ) - \frac{L}{D} sin θ}{1 + \frac{d}{D} cos θ} .$$

In various embodiments, the method may include detecting, by the processor, that the vehicle is moving in the reverse direction and that the trailer is coupled to the vehicle, wherein the step of adjusting the front wheels of the vehicle may be performed automatically in response to the detection of the vehicle moving in the reverse direction with the trailer coupled to the vehicle.

In various embodiments, the method may include limiting the desired hitch articulation angle to angles less than a threshold angle. The threshold angle may be equal to or less than a minimum hitch articulation angle necessary to cause the trailer to jackknife such that the hitch articulation angle is an acute angle.

In various embodiments, the method may include adjusting, by the processor, the front wheels of the vehicle as the hitch articulation angle approaches the desired hitch articulation angle to avoid overshooting the desired hitch articulation angle.

A system is provided for operating a vehicle having a trailer coupled thereto for towing of the trailer. In one embodiment, the system includes a steering system including a steering wheel for controlling a position of front wheels of the vehicle, a sensor system configured to sense a steering wheel angle of the steering wheel, wherein the steering wheel angle is defined between a position of the steering wheel rotated about an axis thereof relative to a null position thereof, and a computer system onboard the vehicle and operatively coupled to the steering system and the sensor system, the computer system configured to, by a processor: monitor the steering wheel angle of the steering wheel of the vehicle while the vehicle is operated to move the vehicle and the trailer in a reverse direction relative thereto, and adjust front wheels of the vehicle in a direction relative to a central longitudinal axis of the vehicle such that the trailer turns in an opposite direction as a direction of rotation of the steering wheel about the axis thereof.

In various embodiments, the computer system may be configured to, by the processor: monitor a speed of the vehicle and a hitch articulation angle of the vehicle while the vehicle is operated to move the vehicle and the trailer in the reverse direction relative thereto, the hitch articulation angle defined between the central longitudinal axis of the vehicle and a central longitudinal axis of the trailer, determine a desired hitch articulation angle based on the steering wheel angle, determine a calculated front steering angle based on the desired hitch articulation angle, the speed of the vehicle, and the hitch articulation angle, wherein a front steering angle is defined between a first geometric line coplanar with and perpendicular to an axis of rotation of front wheels of the vehicle and a central longitudinal axis of the vehicle, wherein the calculated front steering angle is configured to cause relative movement between the vehicle and the trailer such that the hitch articulation angle transitions to the desired hitch articulation angle, and adjust the front wheels of the vehicle in a direction relative to the central longitudinal axis of the vehicle such that the front steering angle matches the calculated front steering angle.

In various embodiments, the computer system may be configured to determine, by the processor, the desired hitch articulation angle in accordance with:

$${θ}_{d} = \{ \begin{matrix}{δ}_{w} \leq - {δ}^{*} & {θ}_{m ax} \\ - {δ}^{*} < {δ}_{w} < {δ}^{*} & - K {δ}_{w} \\ {δ}_{w} \geq {δ}^{*} & - {θ}_{m ax}\end{matrix}$$

In various embodiments, the computer system may be configured to, by the processor, receive vehicle data that includes dimensions of the vehicle and trailer data that includes dimensions of the trailer coupled to the vehicle, wherein the computer system may be configured to determine, by the processor, the calculated front steering angle based on the desired hitch articulation angle, the speed of the vehicle, the hitch articulation angle, the vehicle data, and the trailer data.

In various embodiments, the computer system may be configured to determine, by the processor, the calculated front steering angle in accordance with:

$$tan {δ}_{f} = \frac{τ \frac{L}{V} ( {θ}_{d} - θ ) - \frac{L}{D} sin θ}{1 + \frac{d}{D} cos θ}$$

In various embodiments, the computer system may be configured to, by the processor, detect that the vehicle is moving in the reverse direction and that the trailer is coupled to the vehicle, wherein the computer system may be configured to adjust, by the processor, the front wheels of the vehicle automatically via actuators associated therewith in response to the detection of the vehicle moving in the reverse direction with the trailer coupled to the vehicle.

In various embodiments, the computer system may be configured to, by the processor, limit the desired hitch articulation angle to angles less than a threshold angle, wherein the threshold angle is equal to or less than a minimum hitch articulation angle necessary to cause the trailer to jackknife such that the hitch articulation angle is an acute angle.

In various embodiments, the computer system may be configured to, by the processor, adjust the front wheels of the vehicle as the hitch articulation angle approaches the desired hitch articulation angle to avoid overshooting the desired hitch articulation angle.

A vehicle is provided that, in one embodiment, includes a trailer pivotally coupled to the vehicle for towing of the trailer, a steering system including a steering wheel for controlling a position of front wheels of the vehicle, a sensor system configured to sense a steering wheel angle of the steering wheel, wherein the steering wheel angle defined between a position of the steering wheel rotated about an axis thereof relative to a null position thereof, and a computer system onboard the vehicle and operatively coupled to the steering system and the sensor system, the computer system configured to, by a processor: receive vehicle data that includes dimensions of the vehicle and trailer data that includes dimensions of the trailer coupled to the vehicle, monitor the steering wheel angle of the steering wheel of the vehicle, a speed of the vehicle, and a hitch articulation angle of the vehicle while the vehicle is operated to move the vehicle and the trailer in a reverse direction relative thereto, the hitch articulation angle defined between the central longitudinal axis of the vehicle and the central longitudinal axis of the trailer, determine a desired hitch articulation angle based on the steering wheel angle, determine a calculated front steering angle based on the desired hitch articulation angle, the speed of the vehicle, the hitch articulation angle, the vehicle data, and the trailer data, a front steering angle defined between a first geometric line coplanar with and perpendicular to an axis of rotation of front wheels of the vehicle and the central longitudinal axis of the vehicle, wherein the calculated front steering angle is configured to cause relative movement between the vehicle and the trailer such that the hitch articulation angle transitions to the desired hitch articulation angle, and adjust the front wheels of the vehicle in a direction relative to the central longitudinal axis of the vehicle such that the trailer turns in an opposite direction as a direction of rotation of the steering wheel about the axis thereof and the front steering angle matches the calculated front steering angle.

In various embodiments, the computer system of the vehicle may be configured to, by the processor, determine the desired hitch articulation angle in accordance with:

$${θ}_{d} = \{ \begin{matrix}{δ}_{w} \leq - {δ}^{*} & {θ}_{m ax} \\ - {δ}^{*} < {δ}_{w} < {δ}^{*} & - K {δ}_{w} \\ {δ}_{w} \geq {δ}^{*} & - {θ}_{ma x}\end{matrix} , and$$

determine the calculated front steering angle in accordance with:

$$tan {δ}_{f} = \frac{τ \frac{L}{V} ( {θ}_{d} - θ ) - \frac{L}{D} sin θ}{1 + \frac{d}{D} cos θ}$$

In various embodiments, the computer system of the vehicle may be configured to, by the processor, limit the desired hitch articulation angle to angles less than a threshold angle, wherein the threshold angle is equal to or less than a minimum hitch articulation angle necessary to cause the trailer to jackknife such that the hitch articulation angle is an acute angle.

In various embodiments, the computer system of the vehicle may be configured to, by the processor, adjust the front wheels of the vehicle as the hitch articulation angle approaches the desired hitch articulation angle to avoid overshooting the desired hitch articulation angle.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle that includes a trailer steering assistance system, in accordance with various embodiments;

FIG. 2 is a top view of the vehicle of FIG. 1 illustrating various aspects of the vehicle and the trailer coupled thereto, in accordance with various embodiments;

FIG. 3 is a dataflow diagram illustrating elements of the trailer steering assistance system of the vehicle of FIGS. 1-2, in accordance with various embodiments;

FIG. 4 is a flowchart of a process for maneuvering a trailer as performed by the trailer steering assistance system of the vehicle of FIGS. 1 and 2, in accordance with exemplary embodiments;

FIG. 5 is a top view of the vehicle of FIGS. 1-2 maneuvering a trailer coupled thereto without the trailer steering assistance system;

FIG. 6 is a top view of the vehicle of FIGS. 1-2 maneuvering the trailer coupled thereto with the trailer steering assistance system; and

FIG. 7 is an example of relative values of a steering wheel angle, a front steering angle, and a hitch articulation angle of the vehicle of FIGS. 1-2 while performing a reversing maneuver, such as the maneuvers of FIG. 6, in accordance with exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

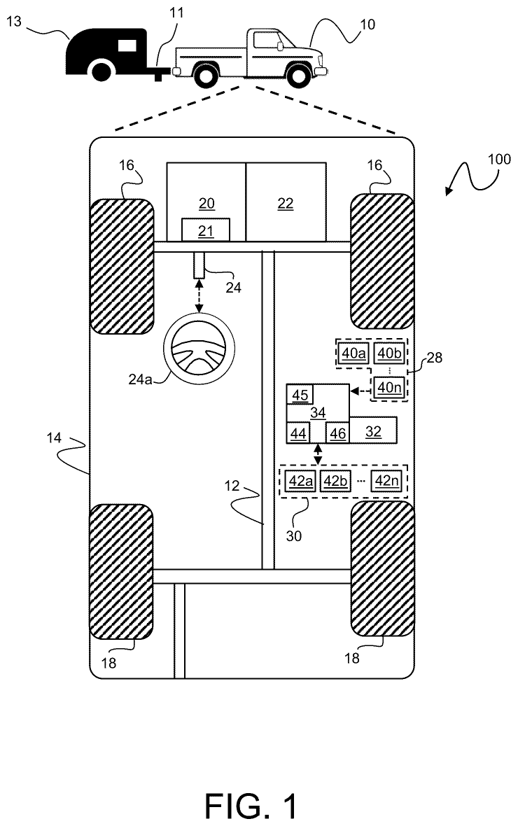

FIG. 1 illustrates a vehicle 10, according to an exemplary embodiment that includes a trailer steering assistance system 100. In general, the system 100 provides dynamic front wheel control to the vehicle 10 to promote intuitive steering for an operator of the vehicle 10 while traveling in reverse with a trailer 13 coupled to the vehicle 10. In various embodiments, the system 100 controls front wheels 16 of the vehicle 10 such that the operator may steer the vehicle 10 in substantially the same manner with or without the trailer 13 coupled thereto.

In certain embodiments, the vehicle 10 comprises an automobile. In various embodiments, the vehicle 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In addition, in various embodiments, it will also be appreciated that the vehicle 10 may comprise any number of other types of mobile platforms.

In various embodiments, the vehicle 10 may be associated with the trailer 13 capable of hauling a load. As can be appreciated, the trailer 13 may be any type of towable application having one or more wheels and is not limited to any one embodiment. The vehicle 10 is configured to couple to and connect to the trailer 13 via a connection apparatus 11 and is configured to tow the trailer 13. In various embodiments, the connection apparatus 11 comprises a hitch. In various other embodiments, the connection apparatus 11 comprises one or more other types of systems, such as a ball-type connection, a gooseneck-type connection, a fifth wheel-type connection, and so on. In various embodiments, the connection apparatus 11 further comprises a wiring harness configured to communicate power and/or communication signals to and from components of the trailer 13.

As depicted in FIG. 1, the exemplary vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

The vehicle 10 further includes a propulsion system 20, a transmission system 22, a steering system 24, a sensor system 28, an actuator system 30, at least one data storage device 32, and at least one controller 34. The propulsion system 20 includes an engine 21, such as a gasoline or diesel fueled combustion engine, an electric engine such as a traction motor, and/or a fuel cell propulsion system.

The transmission system 22 is configured to transmit power from the propulsion system 20 to the wheels 16-18 according to selectable speed ratios based on a range selection received from a human-machine interface, for example, a range selection device (e.g., gear selector, gear shifter, PRNDL, etc.) configured to select an operating range (e.g., gear ratio). According to various embodiments, the transmission system 22 may include a step-ratio automatic transmission, a continuously-variable transmission, or other appropriate transmission.

The steering system 24 influences a position of the wheels 16-18. While depicted as including a steering wheel 24a for illustrative purposes, in some embodiments contemplated within the scope of the present disclosure, the steering system 24 may not include a steering wheel. In various embodiments, the steering system 24 may be a “steer-by-wire” system wherein the steering wheel 24a and actuators configured to change angles of the wheels 16-18 are not mechanically connected, rather communication therebetween is provided by electronic signals.

The sensor system 28 includes one or more sensing devices 40a-40n that sense observable conditions of the exterior environment, the interior environment, and/or a status or condition of a corresponding component of the vehicle 10 and provide such condition and/or status to other systems of the vehicle 10, such as the controller 34. It should be understood that the vehicle 10 may include any number of the sensing devices 40a-40n. The sensing devices 40a-40n can include, but are not limited to, radars, lidars, global positioning systems, optical cameras, thermal cameras, ultrasonic sensors, inertial measurement units, pressure sensors, position sensors, speed sensors, steering wheel angle sensors, hitch articulation angle sensors, and/or other sensors.

The actuator system 30 includes one or more actuator devices 42a-42n that control one or more vehicle features such as, but not limited to, the propulsion system 20, the transmission system 22, and the steering system 24. In various embodiments, the vehicle 10 may also include interior and/or exterior vehicle features not illustrated in FIG. 1, such as various doors, a trunk, and cabin features such as air, music, lighting, touch-screen display components, and the like.

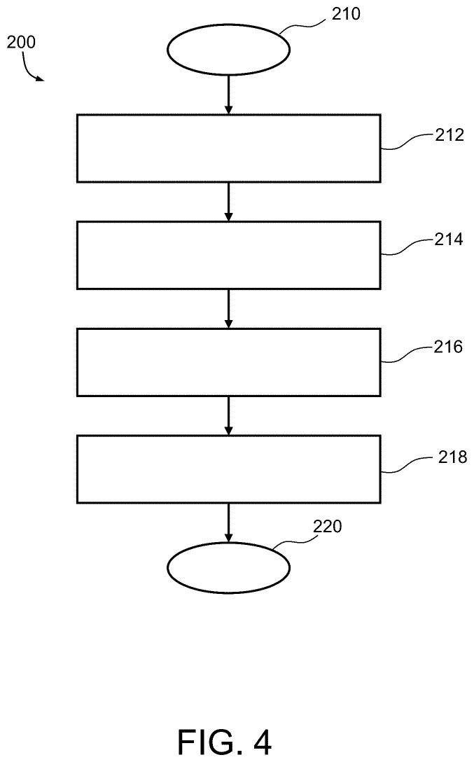

The data storage device 32 stores data for use in controlling the vehicle 10 and/or systems and components thereof. As can be appreciated, the data storage device 32 may be part of the controller 34, separate from the controller 34, or part of the controller 34 and part of a separate system. The data storage device 32 can be any suitable type of storage apparatus, including various different types of direct access storage and/or other memory devices. In one exemplary embodiment, the data storage device 32 comprises a program product from which a computer readable memory device can receive a program that executes one or more embodiments of one or more processes of the present disclosure, such as the steps of the process discussed further below in connection with FIGS. 4-6. In another exemplary embodiment, the program product may be directly stored in and/or otherwise accessed by the memory device and/or one or more other disks and/or other memory devices. In various embodiments, the data storage device 32 stores defined values for controlling the vehicle 10 and/or defined values for the trailer 13.

The controller 34 includes at least one processor 44, a communication bus 45, and a computer readable storage device or media 46. The processor 44 performs the computation and control functions of the controller 34. The processor 44 can be any custom made or commercially available processor, a central processing unit (CPU), a graphics processing unit (GPU), an auxiliary processor among several processors associated with the controller 34, a semiconductor-based microprocessor (in the form of a microchip or chip set), a macro-processor, any combination thereof, or generally any device for executing instructions. The computer readable storage device or media 46 may include volatile and nonvolatile storage in read-only memory (ROM), random-access memory (RAM), and keep-alive memory (KAM). For example, KAM is a persistent or non-volatile memory that may be used to store various operating variables while the processor 44 is powered down. The computer-readable storage device or media 46 may be implemented using any number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10. The bus 45 serves to transmit programs, data, status and other information or signals between the various components of the vehicle 10 and/or trailer 13. The bus 45 can be any suitable physical or logical means of connecting computer systems and components. This includes, but is not limited to, direct hard-wired connections, fiber optics, infrared, and wireless bus technologies.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms, and generate data based on the logic, calculations, methods, and/or algorithms. Although only one controller 34 is shown in FIG. 1, embodiments of the vehicle 10 can include any number of controllers 34 that communicate over any suitable communication medium or a combination of communication mediums that cooperate to process the sensor signals, perform logic, calculations, methods, and/or algorithms, and generate data.

In various embodiments, one or more instructions of the controller 34 are embodied in the trailer steering assistance system 100 and, when executed by the processor 44, receive data from the sensor system 28 and process the data in order to generate control data for controlling a position of the front wheels 16. The position is controlled in order to dynamically provide assistance to an operator of the vehicle 10 while the vehicle 10 is moving in reverse with the trailer 13 coupled thereto.

As can be appreciated, that the controller 34 may otherwise differ from the embodiment depicted in FIG. 1. For example, the controller 34 may be coupled to or may otherwise utilize one or more remote computer systems and/or other control systems, for example as part of one or more of the above-identified vehicle devices and systems. It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 44) to perform and execute the program. Such a program product may take a variety of forms, and the present disclosure applies equally regardless of the particular type of computer-readable signal bearing media used to carry out the distribution. Examples of signal bearing media include recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 34 may also otherwise differ from the embodiment depicted in FIG. 1, for example in that the computer system of the controller 34 may be coupled to or may otherwise utilize one or more remote computer systems and/or other control systems.

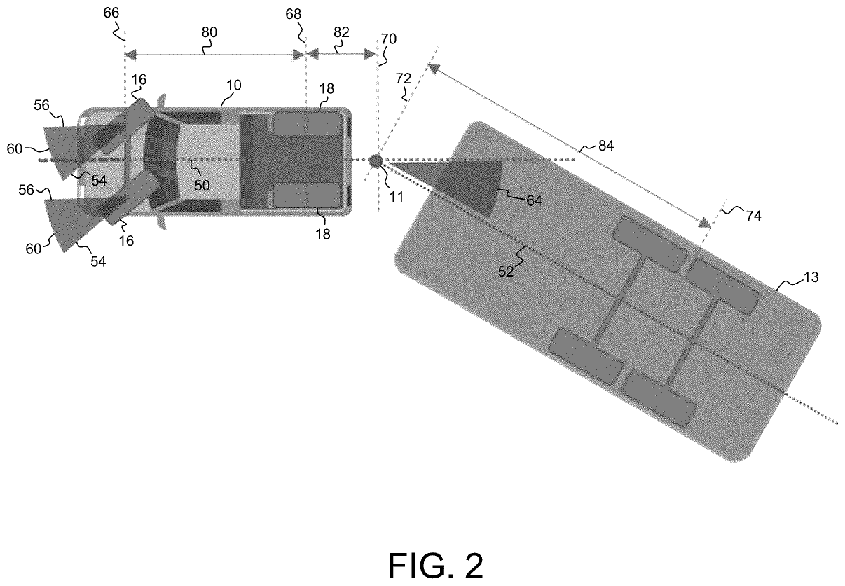

Referring to FIG. 2, the vehicle 10 and the trailer 13 are presented from a top view illustrating various aspects thereof used herein to describe various embodiments of the invention. In particular, FIG. 2 presents a central longitudinal axis 50 of the vehicle 10, a central longitudinal axis 52 of the trailer 13, front steering angles 60, and a hitch articulation angle 64. As used herein, the front steering angles 60 are first and second angles as measured between first geometric lines 54 that are coplanar with and perpendicular to central axes of rotation of the front wheels 16, and the central longitudinal axis 50 of the vehicle 10 or geometric lines 56 parallel therewith. The hitch articulation angle 64 is a third angle as measured between the central longitudinal axis 50 of the vehicle 10, and the central longitudinal axis 52 of the trailer 13.

In addition, FIG. 2 presents a front axle line 66 aligned with a front axle of the vehicle 10, a rear axle line 68 aligned with a rear axis of the vehicle 10, a vehicle connection line 70 aligned with a center of the connection apparatus 11 and perpendicular to the central longitudinal axis 50 of the vehicle 10, a trailer connection line 72 aligned with the center of the connection apparatus 11 and perpendicular to the central longitudinal axis 52 of the trailer 13, and a trailer axle line 74 aligned with a midpoint between axles of the trailer 13 and perpendicular to the central longitudinal axis 52 of the trailer 13. These lines 66-74 define various dimensions that may be used with various calculations performed by the system 100. In particular, FIG. 2 presents a vehicle axle dimension 80 between the front axle line 66 and the rear axle line 68, a vehicle connection dimension 82 between the rear axle line 68 and the vehicle connection line 70, and a trailer connection dimension 84 between the trailer connection line 72 and the trailer axle line 74.

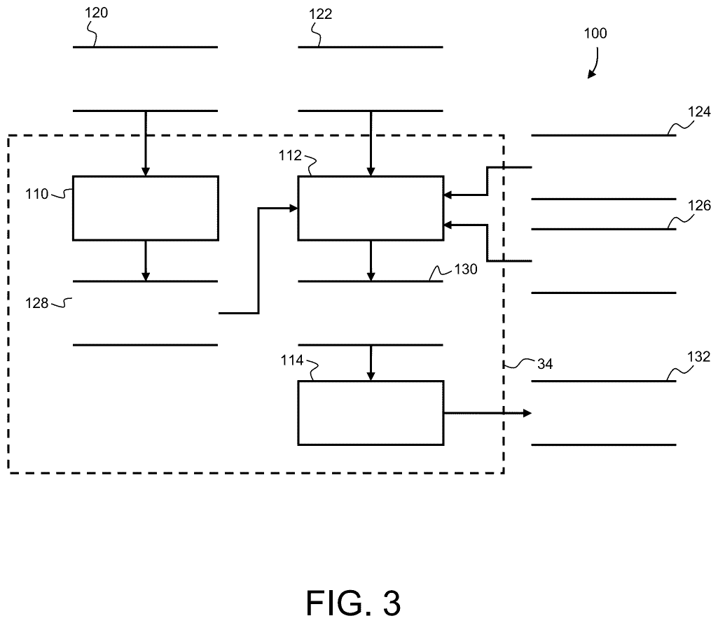

With reference to FIG. 3 and with continued reference to FIGS. 1-2, a dataflow diagram illustrates elements of the system 100 of FIG. 1 in accordance with various embodiments. As can be appreciated, various embodiments of the system 100 according to the present disclosure may include any number of modules embedded within the controller 34 which may be combined and/or further partitioned to similarly implement systems and methods described herein. Furthermore, inputs to the system 100 may be received from other control modules (not shown) associated with the vehicle 10, and/or determined/modeled by other sub-modules (not shown) within the controller 34. Furthermore, the inputs might also be subjected to preprocessing, such as sub-sampling, noise-reduction, normalization, feature-extraction, missing data reduction, and the like. In various embodiments, the system 100 includes a desired hitch angle module 110, a front steering angle module 112, and a steering control module 114.

In various embodiments, the desired hitch angle module 110 receives as input steering wheel angle data 120 generated by the sensor system 28 and/or the steering system 24. The steering wheel angle data 120 includes various data indicating a steering wheel angle (δ_{w}) of the steering wheel 24a (or similar information relating to operator interaction with an input device configured to control the steering of the vehicle 10).

The desired hitch angle module 110 determines a desired hitch articulation angle (θ_{d}) based on the steering wheel angle (δ_{w}) indicated in the steering wheel angle data 120. Various methods and criteria may be used in this determination. In various embodiments, the desired hitch articulation angle (θ_{d}) is determined in accordance with equation 1.

$${θ}_{d} = \{ \begin{matrix}{δ}_{w} \leq - {δ}^{*} & {θ}_{m ax} \\ - {δ}^{*} < {δ}_{w} < {δ}^{*} & - K {δ}_{w} \\ {δ}_{w} \geq {δ}^{*} & - {θ}_{ma x}\end{matrix} \qquad Eq . ( 1 )$$

where K is a constant that indicates a desired hitch angle relative to a steering wheel angle. For example, if the maximum hitch angle is 60 degrees, a K value of 0.5 provides for reaching the maximum hitch angle in 120 degrees (δ\hat{ }*) of the steering wheel input. In some embodiments, K is a value greater than zero and less that one such that a steering wheel angle-to-hitch articulation angle is less than 1:1. Once the desired hitch articulation angle (θ_{d}) has been determined, the desired hitch angle module 110 generates desired hitch articulation angle data 128 including various data indicating the determined desired hitch articulation angle (θ_{d}).

With the above-noted equation (1), ergonomic comfort of the steering may be promoted for the operator, since the operator only needs to operate the steering wheel 24a in a limited range between −δ* to δ* to reach to maximum hitch angle range between −θₘₐₓ to θₘₐₓ. However, the control logic of equation (1) is a nonlimiting example, and other control logic may be implemented.

In various embodiments, the front steering angle module 112 receives as input profile data 122 retrieved from the data storage device 32 and/or the computer readable storage device or media 46, vehicle speed data 124 generated by the sensor system 28, hitch articulation angle data 126 generated by the sensor system 28 or estimated based on data generated by the sensor system 28, and the desired hitch articulation angle data 128 generated by the desired hitch angle module 110. The profile data 122 includes various data indicating aspects of the vehicle 10 and the trailer 13 such as but not limited to the vehicle axle dimension 80, the vehicle connection dimension 82, and the trailer connection dimension 84. The vehicle speed data 124 includes various data indicating the current speed (V) of the vehicle 10. The hitch articulation angle data 126 includes various data indicating the current hitch articulation angle 64 of the trailer 13.

The front steering angle module 112 determines a calculated front steering angle (δ_{f}) based on the desired hitch articulation angle (θ_{d}), the speed (V) of the vehicle 10, and the hitch articulation angle 64. In general, the calculated front steering angle (δ_{f}) corresponds to specific front steering angles 60 configured to cause relative movement between the vehicle 10 and the trailer 13 such that the hitch articulation angle 64 transitions to the desired hitch articulation angle (θ_{d}). Various methods may be used in this determination. In various embodiments, the calculated front steering angle (δ_{f}) is determined in accordance with equation 2.

$$tan {δ}_{f} = \frac{τ \frac{L}{V} ( {θ}_{d} - θ ) - \frac{L}{D} sin θ}{1 + \frac{d}{D} cos θ} \qquad Eq . ( 2 )$$

where τ is an adjustable, positive constant representative of hitch angle control performance. A larger τ value may improve the rate of convergence to θ_{d}. However, increasing τ also increases the front steering angle. Therefore, the value of τ is a trade-off between the hitch angle control performance and maximum available front steering angle. L is the vehicle wheelbase dimension 80, V is speed of the vehicle 10, D is the trailer connection dimension 84, d is the vehicle connection dimension 82, and θ is the hitch articulation angle 64. Once the calculated front steering angle (δ_{f}) is determined, the front steering angle module 112 generates front steering angle data 130 that includes various data indicating the calculated front steering angle (δ_{f}).

The above-noted equation (2) is a nonlimiting example of control logic that may control front steering angle in an effective manner. However, other control logic may be implemented.

In various embodiments, the steering control module 114 receives as input the front steering angle data 130 generated by the front steering angle module 112. The steering control module 114 generates steering control data 132 that includes various data indicating instructions to the steering system 24 for adjusting the front wheels 16 of the vehicle 10 in a direction relative to the central longitudinal axis 50 of the vehicle 10 such that the front steering angles 60 match the calculated front steering angle (δ_{f}).

With reference now to FIG. 4 and with continued reference to FIGS. 1-3, a flowchart provides a method 200 for trailer steering assistance as performed by the system 100, in accordance with exemplary embodiments. As can be appreciated in light of the disclosure, the order of operation within the method 200 is not limited to the sequential execution as illustrated in FIG. 4, but may be performed in one or more varying orders as applicable and in accordance with the present disclosure. In various embodiments, the method 200 can be scheduled to run based on one or more predetermined events, and/or can run continuously during operation of the vehicle 10.

In one example, the method 200 may start at 210. At 212, the method 200 may include monitoring, by a processor (e.g., the processor 44), the steering wheel angle (δ_{w}) of a steering wheel of the vehicle (e.g., the steering wheel 24a of the vehicle 10), a speed (V) of the vehicle, and a hitch articulation angle of the vehicle while the vehicle is operated to move the vehicle and a trailer (e.g., the trailer 13) coupled thereto in a reverse direction. At 214, the method 200 may include determining, by the processor, the desired hitch articulation angle (θ_{d}) based on the steering wheel angle (δ_{w}). At 216, the method 200 may include determining, by the processor, the calculated front steering angle (δ_{f}) based on the desired hitch articulation angle (θ_{d}), the speed (V) of the vehicle, and the hitch articulation angle 64. The calculated front steering angle (δ_{f}) is configured to cause relative movement between the vehicle and the trailer such that the hitch articulation angle 64 transitions to the desired hitch articulation angle (θ_{d}). At 218, the method 200 may include adjusting the front wheels of the vehicle in a direction relative to the central longitudinal axis of the vehicle such that the front steering angles 60 match the calculated front steering angle (δ_{f}). The method 200 may end at 220.

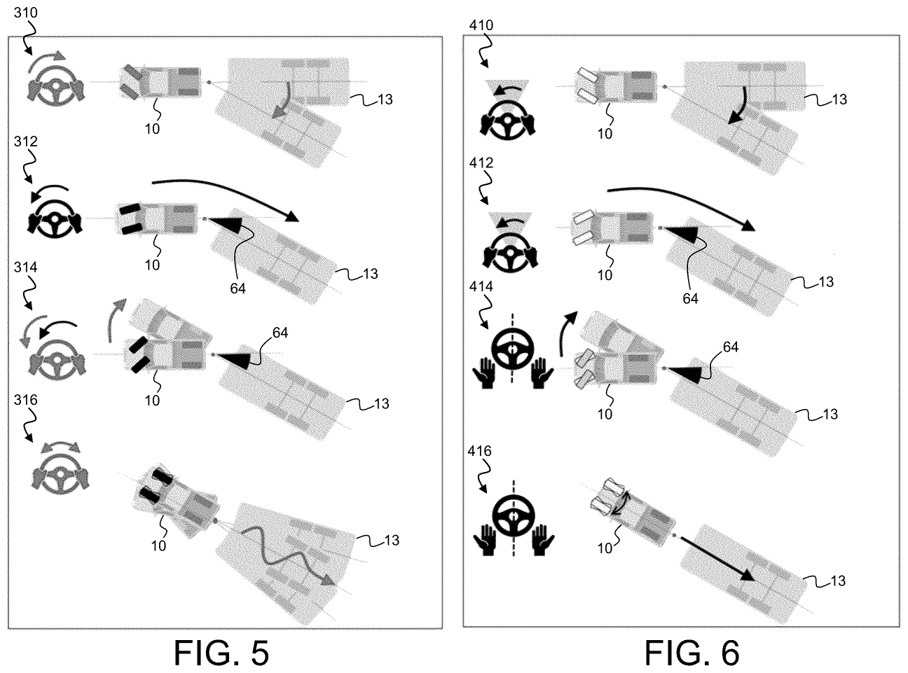

FIGS. 5-6 provide an exemplary comparison between certain maneuvers performed with and without the system 100, respectively. Referring first to FIG. 5, various maneuvers are illustrated while operating the vehicle 10 without the system 100. At 310, the operator rotates the steering wheel 24a of the steering system 24 clockwise and the front wheels 16 turn based thereon toward a passenger's side of the vehicle 10. As the operator drives the vehicle 10 in reverse, the vehicle 10 moves in a direction corresponding to the front steering angles 60 of the front wheels 16, that is, in the passenger's side direction. However, due to the connection apparatus 11, the trailer 13 moves in the operator's side direction while increasing the hitch articulation angle 64. Once a desired hitch articulation angle (θ_{d}) is achieved, the operator rotates the steering wheel 24a counterclockwise at 312 to maintain the hitch articulation angle 64 as the vehicle 10 and the trailer 13 move in reverse.

Once a desired direction of the trailer 13 has been achieved, the operator rotates the steering wheel 24a counterclockwise at 314 to decrease the hitch articulation angle 64 and eventually align the longitudinal axis 50 of the vehicle 10 and the longitudinal axis 52 of the trailer 13. If the operator desires to continue moving in reverse in the desired direction, the alignment of the vehicle 10 and the trailer 13 must be maintained. However, this is often difficult and requires the operator to rotate the steering wheel 24a in clockwise and/or counterclockwise directions at 316 to make small corrections typically resulting in both the vehicle 10 and the trailer 13 moving along wavy paths (represented with arrow) generally centered along the desired direction.

Referring now to FIG. 6, the same types of maneuvers are illustrated while using the system 100. At 410, the operator rotates the steering wheel 24a of the steering system 24 counterclockwise. The system 100 determines the desired hitch articulation angle (θ_{d}) and the calculated front steering wheel angle (δ_{w}) to achieve the desired hitch articulation angle (θ_{d}). The system 100 then turns the front wheels 16 in a direction relative to the central longitudinal axis 50 of the vehicle 10 to achieve the calculated front steering wheel angle (δ_{w}), in this instance, toward the passenger's side of the vehicle 10. As the operator drives the vehicle 10 in reverse, the rear of the vehicle 10 moves in a direction corresponding to the front steering angles 60 of the front wheels 16, that is, in the passenger's side direction. However, due to the connection apparatus 11, the trailer 13 moves in the operator's side direction while increasing the hitch articulation angle 64. Notably, the trailer 13 moves in the same direction as the direction of rotation of the steering wheel 24a relative to the perspective of the operator, that is, turning the steering wheel 24a to the operator's left (i.e., counterclockwise) causes the trailer 13 to move to the operator's left. Stated another way, turning the steering wheel 24a counterclockwise results in the trailer 13 turning in the opposite direction, that is, clockwise (e.g., note −Kδ_{w} in equation (1)). In this manner, the system 100 controls front wheels 16 of the vehicle 10 such that the operator may steer the vehicle 10 in substantially the same manner with or without the trailer 13 coupled thereto.

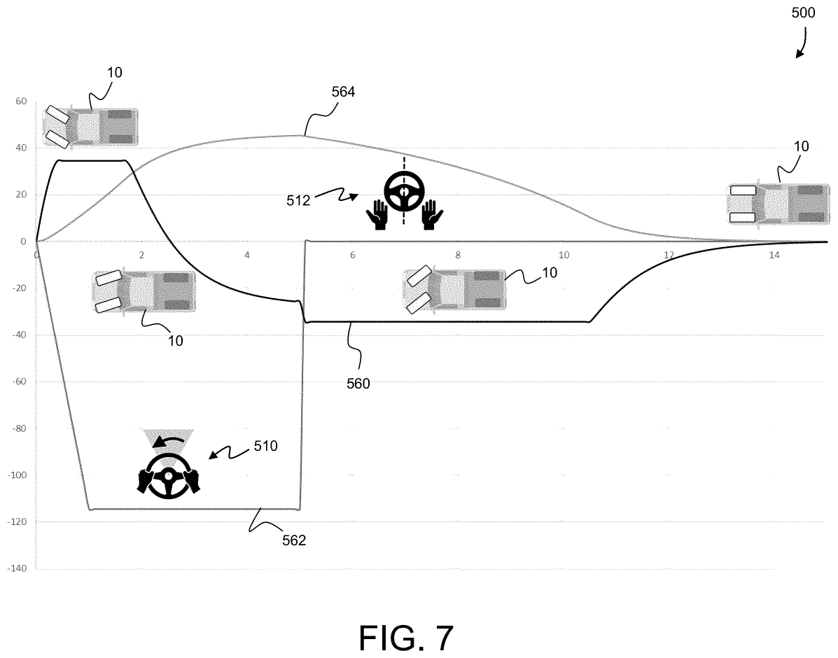

Once the desired hitch articulation angle (θ_{d}) is achieved at 412, the system 100 adjusts the front wheels 16 to achieve a front steering wheel angle (δ_{w}) configured to maintain the hitch articulation angle 64 substantially constant as the vehicle 10 and the trailer 13 move in reverse. In various embodiments, the system 100 may continuously adjust the front steering angles 60 to provide smooth transitions in the relative movement of the vehicle 10 and the trailer 13 and/or to avoid overshooting the desired hitch articulation angle (θ_{d}) and/or the calculated front steering angle (δ_{f}). For example, FIG. 7 schematically represents an example of the steering wheel angle (δ_{w}), the front steering angles 60, and the hitch articulation angle 64 during the maneuvers performed in FIG. 6. In this example, the front steering angles 60 are initially relatively large to increase the hitch articulation angle 64 and then gradually decreases to smoothly transition the hitch articulation angle 64 to the desired hitch articulation angle (θ_{d}). In FIG. 7, the front steering angles 60 over time is represented with a first line 560, the steering wheel angle (δ_{w}) over time is represented with a second line 562, and the hitch articulation angle 64 over time is represented with a third line 564. Representative positions of the steering wheel 24a are indicated at 510 and 512.

Once a desired direction of the trailer 13 has been achieved by the operator, the operator may release the steering wheel 24a or rotate the steering wheel 24a clockwise to a null position thereof (i.e., front steering angles 60 equal to zero) at 414 to indicate a desire to decrease the hitch articulation angle 64 and eventually align the longitudinal axis 50 of the vehicle 10 and the longitudinal axis 52 of the trailer 13 (i.e., achieve a hitch articulation angle 64 equal to zero). In response, the system 100 may adjust the front wheels 16 to perform the maneuver indicated by the operator. In this example, the system 100 may initially turn the front wheels 16 further in the operator's side direction to decrease the hitch articulation angle 64 and then continuously adjust the front steering angles 60 to provide alignment of the vehicle 10 and the trailer 13, preferably without overshooting a hitch articulation angle 64 equal to zero and while simultaneously maintaining a direction of movement of the trailer 13. In the example of FIG. 7, in response to the steering wheel 24a being released, the front steering angles 60 are initially increased (i.e., the front wheels 16 are turned more toward the operator's side) to begin decreasing the hitch articulation angle 64, maintained constant for a period of time to continue decreasing the hitch articulation angle 64, and then gradually decreased to zero as the hitch articulation angle 64 approaches zero.

If the operator desires to continue moving in reverse in the desired direction after the vehicle 10 and the trailer 13 are aligned, the alignment of the vehicle 10 and the trailer 13 may be maintained by the system 100 by making any small corrections necessary by modifying the position of the front wheels 16 thereby allowing the trailer 13 to move in a relatively uniform path in the desired direction without any steering input from the operator at 416. In some embodiments, the system 100 dynamically determines adjustments to the front steering angles 60 while the hitch articulation angle 64 has a value equal to zero and the vehicle 10 is moving in the reverse direction. These adjustments to the front steering angles 60 are configured to maintain alignment of the longitudinal axis 50 of the vehicle 10 and the longitudinal axis 52 of the trailer 13.

A comparison of the examples of FIGS. 5 and 6 illustrate some of the benefits of the system 100. For example, without the system 100 as represented in FIG. 5, the operator is required to perform counter steering to maneuver the trailer 13 in the desired direction, that is, rotating the steering wheel 24a in an opposite direction than normal to move in the desired direction. Counter steering is generally not intuitive to those who do not routinely perform such actions. In contrast, use of the system 100 as represented in FIG. 6 eliminates the requirement of counter steering. Instead, the operator is able to drive the vehicle 10 in substantially the same manner as would be done when the trailer 13 is not coupled thereto. Furthermore, once the trailer 13 has been positioned as desired, the system 100 manages all steering as the vehicle 10 moves in reverse, significantly simplifying the process and alleviating the operator from such responsibility.

It should be noted that the description of the embodiments disclosed herein refers to the pair of front steering angles 60 being equal to each other during turning maneuvers. However, the front steering angles 60 between the pair of front wheels 16 may not be equal. For example, during a turning maneuver, the vehicle 10 may have a turning center point defined by an intersection of the axis of rotation of the operator's side front wheel 16 and the axis of rotation of the passenger's side front wheel 16. Each of the front wheels 16 move along a respective geometric circle about the turning center point. Since the outside front wheel 16 is further from the turning center point (i.e., has a larger radius), the outside front wheel 16 should turn at a lesser angle than the inside front wheel 16, referred to as “toe-out.” As such, in some embodiments, the calculated front steering angle (δf) and, therefore, the front steering angles 60 are determined and implemented by the system 100 as an average of the pair of front steering angles 60. In some embodiments, the calculated front steering angle (δf) and the front steering angles 60 may be determined and implemented by the system 100 may be individually calculated and implemented to the each of the front wheels 16 separately, or such calculations and/or implementations may be adjusted based on the differences caused by the locations of the front wheels 16.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for operating a vehicle having a trailer coupled thereto for towing of the trailer, the method comprising:
monitoring, by a processor onboard the vehicle, a steering wheel angle of a steering wheel of the vehicle while the vehicle is operated to move the vehicle and the trailer in a reverse direction relative thereto, the steering wheel angle defined between a position of the steering wheel rotated about an axis thereof relative to a null position thereof; and
adjusting, by the processor, front wheels of the vehicle in a direction relative to a central longitudinal axis of the vehicle such that the trailer turns in an opposite direction as a direction of rotation of the steering wheel about the axis thereof.

2. The method of claim 1, further comprising:
monitoring, by the processor, a speed of the vehicle and a hitch articulation angle of the vehicle while the vehicle is operated to move the vehicle and the trailer in the reverse direction relative thereto, the hitch articulation angle defined between the central longitudinal axis of the vehicle and a central longitudinal axis of the trailer;
receiving, by the processor, vehicle data that includes dimensions of the vehicle and trailer data that includes dimensions of the trailer coupled to the vehicle,
determining, by the processor, a desired hitch articulation angle based on the steering wheel angle;
determining, by the processor, a calculated front steering angle based on the desired hitch articulation angle, the speed of the vehicle, the hitch articulation angle, the vehicle data, and the trailer data, wherein a front steering angle is defined between a first geometric line coplanar with and perpendicular to an axis of rotation of front wheels of the vehicle and the central longitudinal axis of the vehicle, wherein the calculated front steering angle is configured to cause relative movement between the vehicle and the trailer such that the hitch articulation angle transitions to the desired hitch articulation angle; and
adjusting, by the processor, the front wheels of the vehicle in a direction relative to the central longitudinal axis of the vehicle such that the front steering angle matches the calculated front steering angle.

3. The method of claim 2, wherein determining the desired hitch articulation angle is performed in accordance with:
$${θ}_{d} = \{ \begin{matrix}{δ}_{w} \leq - {δ}^{*} & {θ}_{ma x} \\ - {δ}^{*} < {δ}_{w} < {δ}^{*} & - K {δ}_{w} \\ {δ}_{w} \geq {δ}^{*} & - {θ}_{ma x}\end{matrix} .$$

4. The method of claim 3, wherein K is a value less that one such that a steering wheel angle-to-hitch articulation angle is less than 1:1.

5. The method of claim 2, wherein determining the calculated front steering angle is performed in accordance with:
$$tan {δ}_{f} = \frac{τ \frac{L}{V} ( {θ}_{d} - θ ) - \frac{L}{D} sin θ}{1 + \frac{d}{D} cos θ} .$$

6. The method of claim 1, further comprising detecting, by the processor, that the vehicle is moving in the reverse direction and that the trailer is coupled to the vehicle, wherein adjusting the front wheels of the vehicle is performed automatically in response to the detection of the vehicle moving in the reverse direction with the trailer coupled to the vehicle.

7. The method of claim 2, further comprising limiting the desired hitch articulation angle to angles less than a threshold angle, wherein the threshold angle is equal to or less than a minimum hitch articulation angle necessary to cause the trailer to jackknife such that the hitch articulation angle is an acute angle.

8. The method of claim 2, further comprising:
adjusting, by the processor, the front wheels of the vehicle as the hitch articulation angle approaches the desired hitch articulation angle to avoid overshooting the desired hitch articulation angle.

9. A system for operating a vehicle having a trailer pivotally coupled thereto for towing of the trailer, the system comprising:
a steering system comprising a steering wheel for controlling a position of front wheels of the vehicle;
a sensor system configured to sense a steering wheel angle of the steering wheel, the steering wheel angle defined between a position of the steering wheel rotated about an axis thereof relative to a null position thereof; and
a computer system onboard the vehicle and operatively coupled to the steering system and the sensor system, the computer system configured to, by a processor:
monitor the steering wheel angle of the steering wheel of the vehicle while the vehicle is operated to move the vehicle and the trailer in a reverse direction relative thereto; and
adjust front wheels of the vehicle in a direction relative to a central longitudinal axis of the vehicle such that the trailer turns in an opposite direction as a direction of rotation of the steering wheel about the axis thereof.

10. The system of claim 9, wherein the computer system is configured to, by the processor:
monitor a speed of the vehicle and a hitch articulation angle of the vehicle while the vehicle is operated to move the vehicle and the trailer in the reverse direction relative thereto, the hitch articulation angle defined between the central longitudinal axis of the vehicle and a central longitudinal axis of the trailer;
receive vehicle data that includes dimensions of the vehicle and trailer data that includes dimensions of the trailer coupled to the vehicle
determine a desired hitch articulation angle based on the steering wheel angle;
determine a calculated front steering angle based on the desired hitch articulation angle, the speed of the vehicle, the hitch articulation angle, the vehicle data, and the trailer data, wherein a front steering angle is defined between a first geometric line coplanar with and perpendicular to an axis of rotation of front wheels of the vehicle and the central longitudinal axis of the vehicle, wherein the calculated front steering angle is configured to cause relative movement between the vehicle and the trailer such that the hitch articulation angle transitions to the desired hitch articulation angle; and
adjust the front wheels of the vehicle in a direction relative to the central longitudinal axis of the vehicle such that the front steering angle matches the calculated front steering angle.

11. The system of claim 10, wherein the computer system is configured to determine, by the processor, the desired hitch articulation angle in accordance with:
$${θ}_{d} = \{ \begin{matrix}{δ}_{w} \leq - {δ}^{*} & {θ}_{ma x} \\ - {δ}^{*} < {δ}_{w} < {δ}^{*} & - K {δ}_{w} \\ {δ}_{w} \geq {δ}^{*} & - {θ}_{m ax}\end{matrix} .$$

12. The system of claim 11, wherein K is a value less that one such that a steering wheel angle-to-hitch articulation angle is less than 1:1.

13. The system of claim 10, wherein the computer system is configured to determine, by the processor, the calculated front steering angle in accordance with:
$$tan {δ}_{f} = \frac{τ \frac{L}{V} ( {θ}_{d} - θ ) - \frac{L}{D} sin θ}{1 + \frac{d}{D} cos θ} .$$

14. The system of claim 9, wherein the computer system is configured to, by the processor:
detect that the vehicle is moving in the reverse direction and that the trailer is coupled to the vehicle, wherein the computer system is configured to adjust, by the processor, the front wheels of the vehicle automatically in response to the detection of the vehicle moving in the reverse direction with the trailer coupled to the vehicle.

15. The system of claim 10, wherein the computer system is configured to, by the processor:
limit the desired hitch articulation angle to angles less than a threshold angle, wherein the threshold angle is equal to or less than a minimum hitch articulation angle necessary to cause the trailer to jackknife such that the hitch articulation angle is an acute angle.

16. The system of claim 10, wherein the computer system is configured to, by the processor:
adjust the front wheels of the vehicle as the hitch articulation angle approaches the desired hitch articulation angle to avoid overshooting the desired hitch articulation angle.

17. A vehicle comprising:
a trailer pivotally coupled to the vehicle for towing of the trailer;
a steering system comprising a steering wheel for controlling a position of front wheels of the vehicle;
a sensor system configured to sense a steering wheel angle of the steering wheel, the steering wheel angle defined between a position of the steering wheel rotated about an axis thereof relative to a null position thereof; and
a computer system onboard the vehicle and operatively coupled to the steering system and the sensor system, the computer system configured to, by a processor:
receive vehicle data that includes dimensions of the vehicle and trailer data that includes dimensions of the trailer coupled to the vehicle;
monitor the steering wheel angle of the steering wheel of the vehicle, a speed of the vehicle, and a hitch articulation angle of the vehicle while the vehicle is operated to move the vehicle and the trailer in a reverse direction relative thereto, the hitch articulation angle defined between the central longitudinal axis of the vehicle and the central longitudinal axis of the trailer;
determine a desired hitch articulation angle based on the steering wheel angle;
determine a calculated front steering angle based on the desired hitch articulation angle, the speed of the vehicle, the hitch articulation angle, the vehicle data, and the trailer data, wherein a front steering angle is defined between a first geometric line coplanar with and perpendicular to an axis of rotation of front wheels of the vehicle and the central longitudinal axis of the vehicle, wherein the calculated front steering angle is configured to cause relative movement between the vehicle and the trailer such that the hitch articulation angle transitions to the desired hitch articulation angle; and
adjust the front wheels of the vehicle in a direction relative to the central longitudinal axis of the vehicle such that the trailer turns in an opposite direction as a direction of rotation of the steering wheel about the axis thereof and the front steering angle matches the calculated front steering angle.

18. The vehicle of claim 17, wherein the computer system is configured to, by the processor:
determine the desired hitch articulation angle in accordance with:
$${θ}_{d} = \{ \begin{matrix}{δ}_{w} \leq - {δ}^{*} & {θ}_{m ax} \\ - {δ}^{*} < {δ}_{w} < {δ}^{*} & - K {δ}_{w} \\ {δ}_{w} \geq {δ}^{*} & - {θ}_{m ax}\end{matrix} ; and ,$$
determine the calculated front steering angle in accordance with:
$$tan {δ}_{f} = \frac{τ \frac{L}{V} ( {θ}_{d} - θ ) - \frac{L}{D} sin θ}{1 + \frac{d}{D} cos θ} .$$

19. The vehicle of claim 17, wherein the computer system is configured to, by the processor:
limit the desired hitch articulation angle to angles less than a threshold angle, wherein the threshold angle is equal to or less than a minimum hitch articulation angle necessary to cause the trailer to jackknife such that the hitch articulation angle is an acute angle.

20. The vehicle of claim 17, wherein the computer system is configured to, by the processor:
adjust the front wheels of the vehicle as the hitch articulation angle approaches the desired hitch articulation angle to avoid overshooting the desired hitch articulation angle.
